(19) United States
(12) Patent Application Publication
(10) Pub. No.: US 2016/0267569 A1
(43) Pub. Date: Sep. 15, 2016

(54) Providing Search Results Comprising Purchase Links For Products Associated With The Search Results

(71) Applicant: GOOGLE INC., Mountain View, CA (US)

(72) Inventors: Courtney Hampson, Sunnyvale, CA (US); Jason Robert Richard Sanio, Sunnyvale, CA (US)

(21) Appl. No.: 14/643,367

(22) Filed: Mar. 10, 2015

(51) Int. Cl. G06Q 30/06; G06F 17/22; G06F 3/0484; G06Q 30/02; G06F 17/30

(52) U.S. Cl. CPC G06Q 30/0625; G06Q 30/0256; G06F 17/30864; G06F 3/04842; G06F 17/2235; G06F 17/30554

(57) ABSTRACT

A search system receives an image search query from a user and retrieves image search results. For each image search result, the search system identifies a product based on metadata associated with the image search result. For each image search result, the search system associates an offer for the product corresponding to the image search result. For each image search result, the search system identifies a purchase link for the product associated with the offer associated with each image search result and generates a purchase icon within the image search result comprising the purchase link. The search system presents the image search results comprising the purchase icons to the user. The user selects a purchase icon of an image search result and the user computing device web browser is redirected to a website where the user may purchase the product corresponding to the purchase link.

### TECHNICAL FIELD

The present disclosure relates to improving user convenience in online shopping by providing a direct link to purchase a product in a search result.

### BACKGROUND

Users conduct searches online for items that they are interested in purchasing. Particularly, users may conduct image searches so that they can have a visualization of the product that they are interested in purchasing. However, once a user has searched for an item and views search results associated with the item, a user must then access a website at which the user may initiate a purchase of the item. If the search result links to a merchant website, then the user must click the search result then click one or more options on the merchant website to purchase the item. If the search result does not link to a merchant website, then the user must first find the item on a merchant website or shopping application before purchasing the item. Thus, the process for purchasing an item associated with search results is inconvenient to the user and consumes unnecessary bandwidth and processing power.

### SUMMARY

Techniques herein provide computer-implemented methods to provide image search results comprising purchase links for products associated with the image search results are provided. A search system receives an image search from a user and retrieves image search results based on the image search. For each image search result, the search system identifies a product based on metadata associated with the image search result. For each image search result, the search system associates an offer for the product corresponding to the image search result based on comparing metadata associated with the image search result to metadata associated with offers. For each image search result, the search system identifies a purchase link for the product associated with the offer associated with each image search result and generates a purchase icon within the image search result comprising the purchase link. The search system presents the image search results comprising the purchase icons to the user in response to the user's image search. The user selects, via the user computing device, a purchase icon of an image search result and the user computing device web browser is redirected to a website where the user may purchase the product corresponding with the purchase link.

In certain other example aspects described herein, systems and computer program products to provide image search results comprising purchase links for products associated with the image search results are provided.

In certain other example aspects described herein, computer-implemented methods, systems, and computer program products to provide text search results, audio search results, image search results, and/or video search results comprising purchase links for products associated with the respective search results are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for providing image results comprising purchase links for products associated with the images, in accordance with certain example embodiments.

FIG. 2 is a block flow diagram depicting a method for providing image results comprising purchase links for products associated with the images, in accordance with certain example embodiments.

FIG. 3 is a block flow diagram depicting a method for retrieving image results in response to receiving a user image search, in accordance with certain example embodiments.

FIG. 4 is a block flow diagram depicting a method for identifying offers to associate with image results based on metadata associated with image results and metadata associated with offers, in accordance with certain example embodiments.

FIG. 5 is a block flow diagram depicting a method for completing an online purchase of the product associated with selected image result, in accordance with certain example embodiments.

FIG. 6 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques to provide image search results comprising purchase links for products associated with the image search results. In an example embodiment, a search system receives an image search from a user and retrieves image search results based on the image search. For each image search result, the search system identifies a product based on metadata associated with the image search result. For each image search result, the search system associates an offer for the product corresponding to the image search result based on comparing metadata associated with the image search result to metadata associated with offers. For each image search result, the search system identifies a purchase link for the product associated with the offer associated with each image search result and generates a purchase icon within the image search result comprising the purchase link. The search system presents the image search results comprising the purchase icons to the user in response to the user's image search. The user selects, via the user computing device, a purchase icon of an image search result and the user computing device web browser is redirected to a website where the user may purchase the product corresponding with the purchase link.

In an example embodiment, a user accesses a search website via a user computing device. For example, the user enters the website address of the search website into a web browser of the user computing device. In another example, the user selects a search application resident on the user computing device that communicates with the search website. The user submits a search query using the user computing device. In an example, the user submits one or more search terms comprising a combination of characters, alphabetical letters, symbols, blank spaces, and/or words. The search system receives the search query and retrieves image search results associated with the search query. For example, the search system retrieves image search results corresponding to one or more of the one or more search terms submitted by the user in the search query. In an example, the search system comprises a database of image search results that are tagged to match to search terms. In this example, the search system accesses the database of images and retrieves one or more image search results associated with one or more of the search terms received in the user's search query. The search system retrieves metadata associated with the retrieved image search results and identifies a product corresponding to each retrieved image search result based on the metadata associated with the image search results. In an example embodiment, one or more of the retrieved image search results comprise images from one or more corresponding publishers' websites. In this example embodiment, the metadata associated with an image search result comprises text from the corresponding publisher's website. In this example embodiment, the search system retrieves image metadata comprising text in proximity to the image from the publisher's website. For example, the metadata associated with the image search results comprises a text description of a product depicted by the image. In this example, the search system identifies the product depicted by the image based on metadata comprising the text description.

The search system accesses metadata corresponding to offers and retrieves, for each image search result, one or more offers associated with the identified product corresponding to the respective image search result. In an example embodiment, the search system comprises a database of offers. In this example embodiment, offers in the database of offers may be associated with one or more merchant systems offering products for sale. An example offer comprises a description of a product and a price at which the user may purchase the product in an online transaction with a merchant system that sells the product. For each image search result, the search system selects an offer from the one or more retrieved offers to associate with the image search result. For example, the search system selects an offer corresponding to the lowest price at which the product is being offered for sale. In another example, the search system selects an offer corresponding to the lowest total cost including purchasing and shipping the item. In yet another example, the search system selects an offer corresponding to a merchant system that bids for advertising services. The search system identifies, for each image search result, a purchase link associated with the selected offer corresponding to the image search result. In an example embodiment, the purchase link is a merchant system website address that initiates an online transaction for the product. In another example embodiment, the link comprises a link to shopping search results corresponding to the product from a shopping service associated with the search system.

In an example embodiment, the search system generates, for each image search result, a purchase icon within the image search result comprising the corresponding purchase link. For example, the purchase icon is superimposed on the image within the boundaries of the image. In another example, all or part of the image comprises the purchase icon. The search system presents the image search results comprising the corresponding purchase icons to the user computing device to display in response to the user's image search. The user selects a purchase icon of an image search result. For example, the user actuates an object on the user interface of the user computing device to select the purchase icon. For example, the user clicks, touches, or otherwise selects the purchase icon via the user computing device. In this example, the search system receives an indication of the user selection from the user computing device.

The web browser of the computing device is redirected to the merchant system website associated with the purchase link and the offer on the merchant system website is displayed on the user computing device. In another example embodiment, an application that communicates with the merchant system website resident on the user computing device opens in response to the user selecting the purchase icon. The user selects an option on the merchant system website to purchase the product associated with the offer. For example, the user clicks a user interface object that reads “purchase now.” The merchant website requests payment and shipping information from the user and the user enters the requested information. For example the user may enter a shipping address and payment information associated with one or more of a credit card account, a coupon, a voucher, a rewards points account, a bank account, a merchant system store account, or any other applicable account that may be used in an online purchase transaction with the merchant system. The user selects an option to approve a payment transaction to purchase the product and the merchant system processes the payment transaction initiated by the user. In an example embodiment, the merchant system communicates with an issuer system, such as a credit card issuer system or coupon issuer system, associated with payment information provided by the user for use in the payment transaction.

In certain other example embodiments, instead of or in addition to providing image search results, the search system provides text search results, audio search results, and/or video search results. In these example embodiments, the search system may provide one type of search results (for example, only video search results) or may provide a combination of two or more types of search results (for example, video, image, and text search results). In these example embodiments, a search system receives a search from a user and retrieves appropriate results based on the search. For example, the search system retrieves video search results, text search results, audio search results, and/or image search results. For each search result, the search system identifies a product based on metadata associated with the search result. For each search result, the search system associates an offer for the product corresponding to the search result based on comparing metadata associated with the image search result to metadata associated with offers.

For each search result, the search system identifies a purchase link for the product associated with the offer associated with each search result and generates a purchase icon within the search result comprising the purchase link. For example, the search system generates the purchase icon in the form of an annotation to a text search result. In another example, the search system generates the purchase icon as an interface object superimposed over a region of a video search result as the video search result is being played after the user selects to play the video in the video search result. In this example embodiment, the purchase icon may be an annotation beside the video search result. In yet another example embodiment, the purchase icon may comprise an interface object superimposed over a region of an image search result. The search system presents the search results comprising the purchase icons to the user in response to the user's search. In another example embodiment, the search system provides a purchase icon to a publisher's website from which the search system obtained an image search result to associate with the image search result and to be displayed on the publisher's website.

The user selects, via the user computing device, a purchase icon of search result and the user computing device web browser is redirected to a website where the user may purchase the product corresponding with the purchase link. For example, the user computing device web browser may be redirected to a merchant system website. In this example, the merchant website may show the product associated with the image result in a virtual shopping cart and display an option to check out or purchase the item. In this example, the user may enter shipping and/or payment information into the merchant website and select an option to purchase. In another example, when the user selects the purchase icon, an application associated with the merchant system opens on the user computing device. In this example, the user selects an option to check out, enters shipping and payment information, and selects an option to initiate a purchase of the item via the application, which communicates with the merchant system via a network.

By using and relying on the methods and systems described herein, the search system provides the user with a purchase link for an item associated with a search result in a search result in response to receiving a user search query. Additionally, the user, via the user computing device, by selecting a purchase link directly from a search result, does not have to manually search for a product to purchase in a shopping application or a merchant website. As such, the systems and methods described herein may provide a convenience to the user while also reducing bandwidth and processing required for linking a user to a product for purchase.

### Example System Architecture

Turning now to the drawings, in which like numerals indicate like (but not necessarily identical) elements throughout the figures, example embodiments are described in detail.

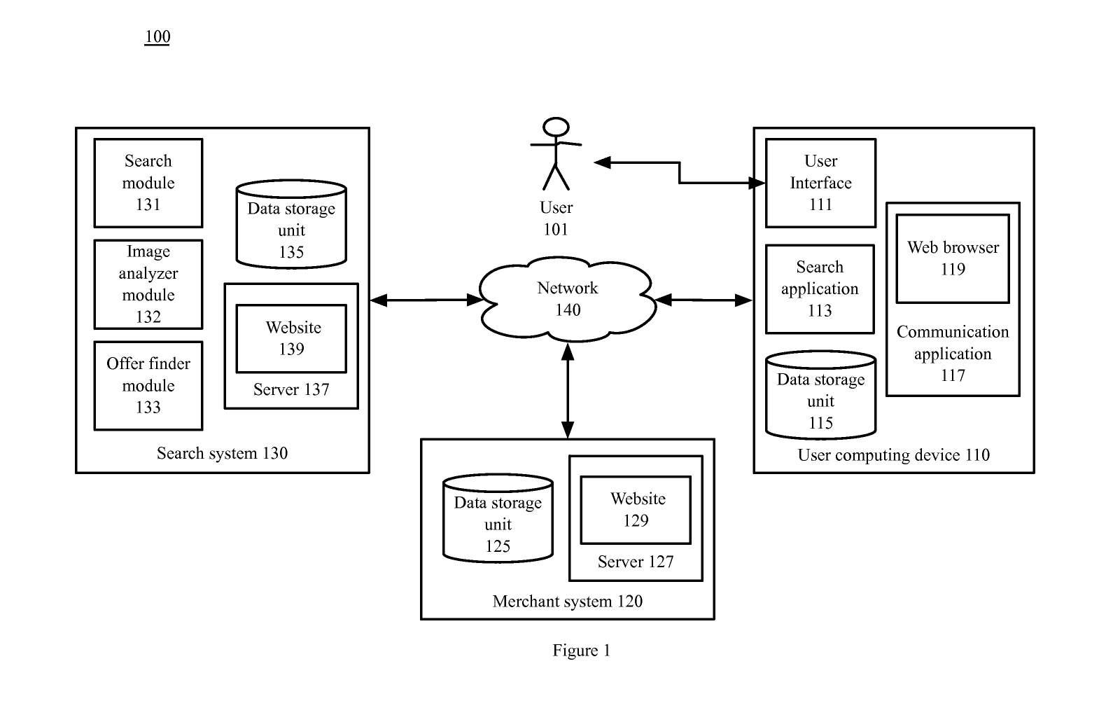

FIG. 1 is a block diagram depicting a system 100 for providing image results comprising purchase links for products associated with the images, in accordance with certain example embodiments. As depicted in FIG. 1, the system 100 includes network computing devices 110, 120, and 130 that are configured to communicate with one another via one or more networks 140. In some embodiments, a user associated with a device must install an application and/or make a feature selection to obtain the benefits of the techniques described herein.

In example embodiments, the network 140 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, and 130 includes a device having a communication module capable of transmitting and receiving data over the network 140. For example, each network computing device 110, 120, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, and 130 are operated by users 101, merchant system 120 operators, and search system 130 operators, respectively.

An example user computing device 110 comprises a user interface 111, a search application 113, a data storage unit 115, a communication application 117, and a web browser 119.

In an example embodiment, the user interface 111 may be a touch screen, a voice-based interface or any other interface that allows the user 101 to provide input and receive output from an application or module on the user computing device 110. In an example embodiment, the user interface 111 enables the user 101 to access a search system website 139 and enter a search query. In an example embodiment, the user 101 selects a purchase icon associated with a search result via the user interface 111. In an example embodiment, the user 101 enters payment information and or shipping information to a merchant website 129 to use in a purchase transaction for a product corresponding with a search result via the user interface 111. In an example embodiment, the user 101 selects an option to confirm the purchase transaction with the merchant website 129 via the user interface 111.

In an example embodiment, the search application 113 is a program, function, routine, applet, or similar entity that exists on and performs its operations on the user computing device 110. In certain embodiments, the user 101 must install the search application 113 and/or make a feature selection on the user computing device 110 to obtain the benefits of the techniques described herein. In an example embodiment, the search application 113 communicates with the search system 130. In an example embodiment, a user 101 downloads the search application 113 from a search system 130 website 139 onto the user computing device 110. In an example embodiment, a user 101 may enter a search query via the search application 113. In an example embodiment, the search application 113 is an image search application 113. For example, the user 101 may search for images using the image search application 113, which communicates with the search system 130 via the network 140. In another example embodiment, the user 101 may use the search application 113, which communicates via the network 140 with the search system 130, to search for one or more of text, videos, images, and audio. In an example embodiment, search application 113 receives one or more search results comprising purchase icons from the search system 130 and displays the search results to the user 101. In an example embodiment, the search application 113 communicates a user 101 selection of a purchase icon to the search system 130.

In certain example embodiments described herein, one or more functions performed by the search application 113 resident on the user computing device 110 may also be performed by a web browser 119 application associated with the search system 130. In certain example embodiments described herein, one or more functions performed by the search system 130 may also be performed by the search application 113. In certain example embodiments described herein, one or more functions performed by the web browser 119 application associated with the search system 130 may also be performed by the search application 113.

In an example embodiment, the data storage unit 115 comprises a local or remote data storage structure accessible to the user computing device 110 suitable for storing information. In an example embodiment, the data storage unit 115 stores encrypted information, such as HTML5 local storage.

In an example embodiment, the user 101 can use a communication application 117, such as a web browser 119 application or a stand-alone application, to view, download, upload, or otherwise access documents or web pages via a distributed network 140. In an example embodiment, the communication application 119 can interact with web servers or other computing devices connected to the network 140, including the user computing device 110 and a web server 127 of a merchant system 120.

In an example embodiment, the web browser 119 can enable the user 101 to interact with web pages using the user computing device 110. In an example embodiment, the search system 130 instructs the user computing device 110 to direct the web browser 119 to redirect to a merchant system website 139 offering a product for sale in response to receiving, from the user computing device 110, an indication of the selection by the user 101 of a purchase icon corresponding to a search result depicting the product.

An example merchant system 120 comprises a data storage unit 125, a server 127, and a website 129.

An example data storage unit 125 comprises a local or remote data storage structure accessible to the merchant system 120 suitable for storing information. In an example embodiment, the data storage unit 125 stores encrypted information, such as HTML5 local storage.

An example search system 130 comprises a search module 131, an image analyzer module 132, an offer finder module 133, a data storage unit 135, a server 137, and a website 139.

In an example embodiment, the search module 131 receives a user's 101 search query from a user computing device 110 associated with the user 101. In an example embodiment, the search module 131 retrieves one or more search results based on the search query. In an example embodiment, the search module 131 communicates with the image analyzer module 132 and/or the offer finder module 133. For example, the search module 131 communicates with the image analyzer module 132 to determine one or more features of an image search result, which the search module 131 compares against one or more corresponding features of other image results to determine a product depicted by an image search result. In an example, the search module 131 communicates with the offer finder module 133 to retrieve one or more offers corresponding to a product depicted in an image search result. In an example embodiment, the search module 131 generates a purchase icon comprising a purchase link for the selected offer. In an example embodiment, the search module 131 transmits one or more search results comprising corresponding purchase icons to the user computing device 110 for display to the user 101. In an example embodiment, the search module 131 receives an indication of a user 101 selection of a purchase icon from the user computing device 110. In an example embodiment, the search module 131 transmits instructions to the user computing device 110 to redirect the web browser 119 of the user computing device 110 to a merchant system website 129 associated with the purchase link corresponding to the selected purchase icon.

In an example embodiment, the image analyzer module 132 determines one or more features of an image result. Example features of the image result may comprise color, pattern, brightness, shape, space, texture, or other properties of the image or of regions of the image associated with the image result. In this example, the image analyzer module 132 determines the features of the image result of the user's 101 search query and compares the features of image result of the user's 101 search query against the features of image results in the search system's 130 database of image results. In an example embodiment, the image analyzer module 132 determines the closest image in the database to the image result based on the comparison of the features of the images and transmits the image to the search module 131, which determines the product depicted by the image.

In an example embodiment, the offer finder module 133 receives a request from the search module 131 to find one or more offers associated with a product identified in an image search result. In an example embodiment, the offer finder module 133 accesses a product offer list catalog to retrieve one or more offers associated with the identified product or otherwise retrieves one or more offers associated with the identified product. In an example embodiment, the offer finder module 133 selects an offer from the one or more retrieved offers to present to the user 101. In this example embodiment, the offer finder module 133 determines a purchase link for the selected offer. In an example embodiment, the offer finder module 133 communicates the selected offer associated with the particular image result and the corresponding purchase link to the search module 131.

In an example embodiment, the data storage unit 135 comprises a local or remote data storage structure accessible to the search system 130 suitable for storing information. In an example embodiment, the data storage unit 135 stores encrypted information, such as HTML5 local storage. In an example embodiment, the data storage unit 135 comprises a product offer listing catalog comprising a list of products and one or more offers associated with each product listing.

In an example embodiment, the server 137 provides the content accessible by the user 101 through the web browser 119 and/or search application 113 resident on the user computing device 110, including but not limited to html documents, images, style sheets, and scripts. In an example embodiment, the server 131 supports the search system website 139.

In an example embodiment, the search system website 139 is a means by which the user 101 interacts with the search system 130. In an example embodiment, the user 101 may enter a search query and receive search results comprising purchase icons via the search system website 139. In an example embodiment, the user 101 accesses the search system website 139 via the web browser 119 of the user computing device 110. In another example embodiment, the user 101 accesses the website 139 via the search application 113 resident on the user computing device 110.

It will be appreciated that the network connections shown are example and other means of establishing a communications link between the computers and devices can be used. Moreover, those having ordinary skill in the art having the benefit of the present disclosure will appreciate that the user computing device 110, the merchant system 120, and the search system 130 illustrated in FIG. 1 can have any of several other suitable computer system configurations. For example, a user computing device 110 embodied as a mobile phone or handheld computer may or may not include all the components described above.

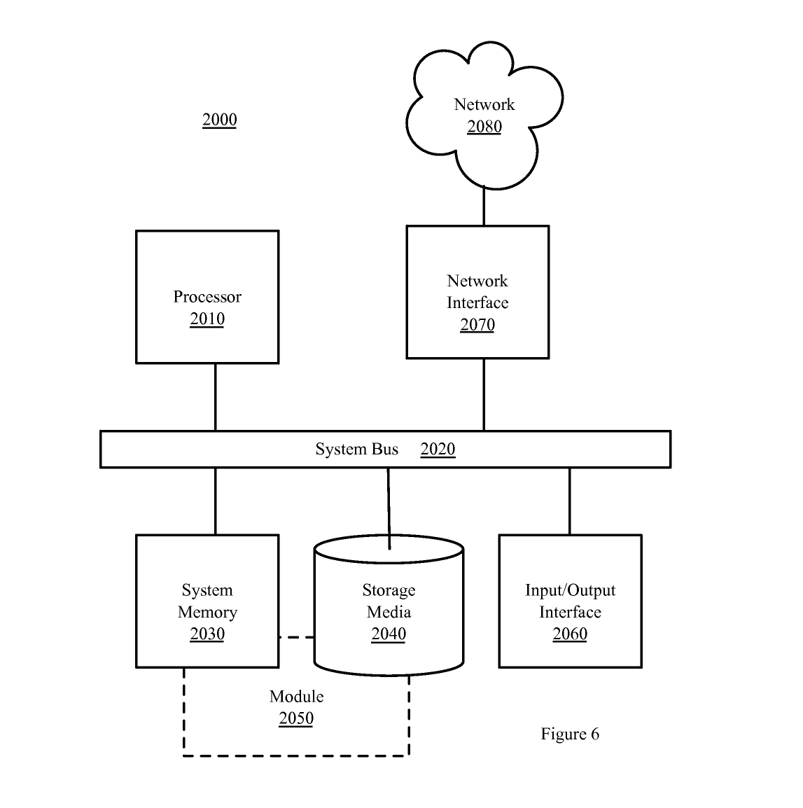

In example embodiments, the network computing devices and any other computing machines associated with the technology presented herein may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may by any of the modules discussed in more detail with respect to FIG. 6. The computing machines discussed herein may communicate with one another as well as other computer machines or communication systems over one or more networks, such as network 140. The network 140 may include any type of data or communications network, including any of the network technology discussed with respect to FIG. 6.

### Example Processes

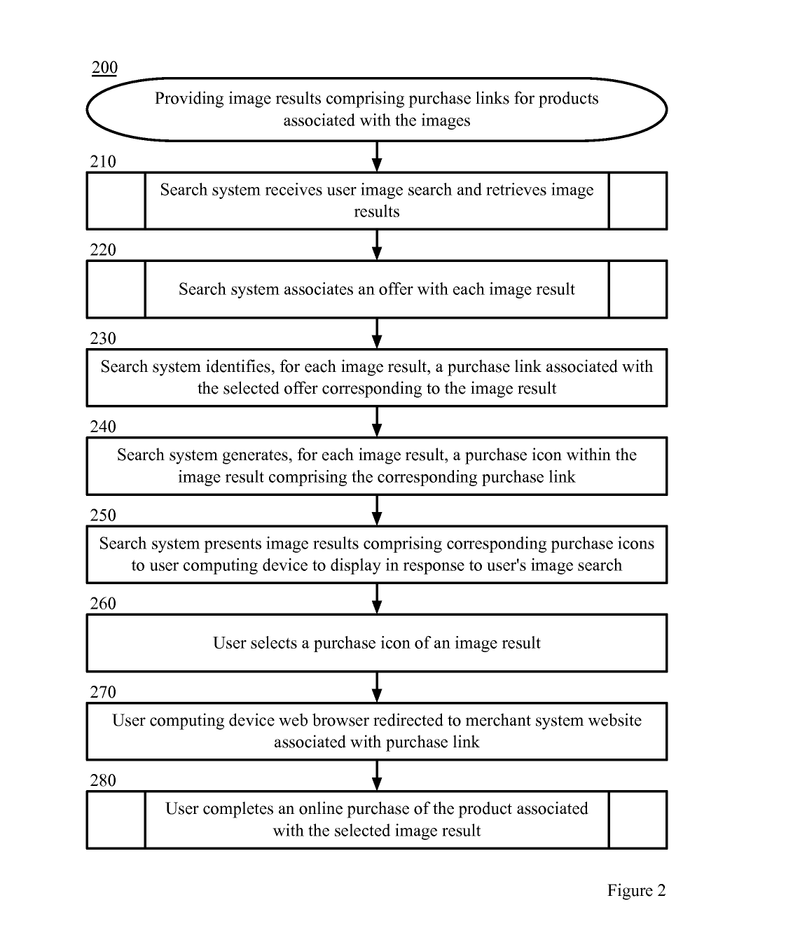

The example methods illustrated in FIGS. 2-5 are described hereinafter with respect to the components of the example operating environment 100. The example methods of FIGS. 2-5 may also be performed with other systems and in other environments.

FIG. 2 is a block diagram depicting a method 200 for providing image results comprising purchase links for products associated with the images, in accordance with certain example embodiments. The method 200 is described with reference to the components illustrated in FIG. 1. In certain other example embodiments, text search results, audio search results, visual search results, and/or image search results comprising purchase links for products associated with the respective search results are provided.

In block 210, a search system receives a user 101 image search query and retrieves image results. In other example embodiments, a search system receives a user 101 search query and retrieves text search results, video search results, audio search results and/or image search results.

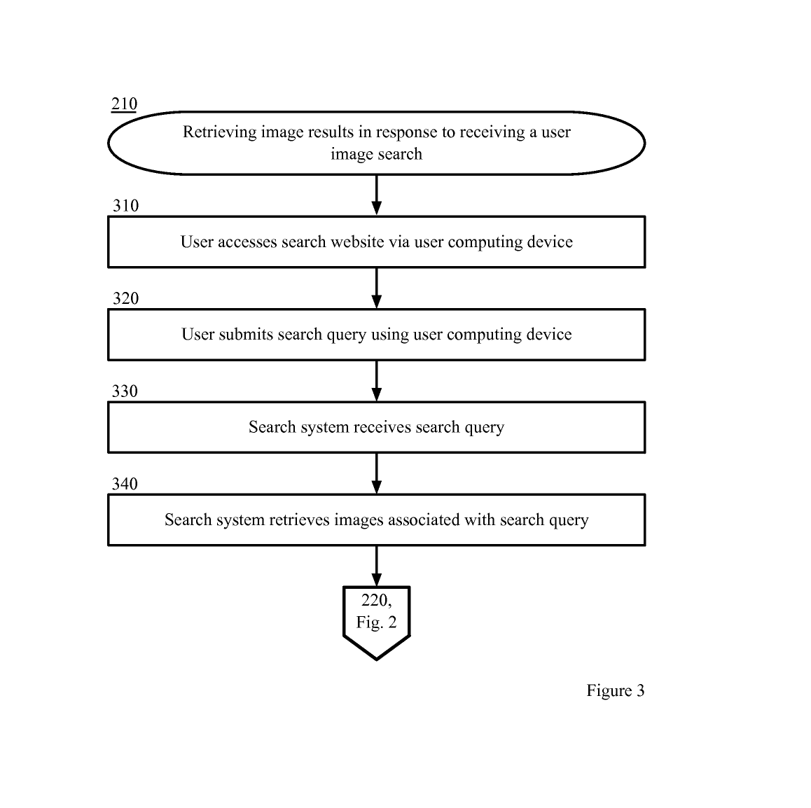

FIG. 3 is a block diagram depicting a method 210 for retrieving image results in response to receiving a user image search, in accordance with certain example embodiments. The method 210 is described with reference to the components illustrated in FIG. 1.

In block 310, the user 101 accesses a search system website 139. In an example embodiment, the user 101 enters, via the user interface 111, the website address associated with the search system website 139 into the user computing device web browser 119 and accesses the website 139 via the network 140. In another example embodiment, the user 101 is viewing a website other than the search system website 139 in the web browser 119 and clicks a link on the other website, which redirects the web browser 119 to the search system website 139. In yet another example embodiment, the user 101 accesses the search system website 139 and downloads a search application 113 onto the user computing device 110 over the network 140. In this example embodiment, the search application 113 resident on the user computing device 110 communicates with the search system website 139 over the network 140 to enable the user 101 to access the search system website 139 via the search application 113. For example, the user 101 selects the search application 113 on the user computing device 110 to access the search system website 139. An example search system website 139 comprises an image search website 139 that can retrieve images, a video search website 139 that can retrieve videos, a text search website 139 that can retrieve text, or an audio search website 139 that can retrieve audio files. In an example embodiment, the search website 139 can retrieve more than one type of media. For example, the search website 139 can retrieve images, video files, text, and/or audio files.

In block 320, a user 101 submits a search query using the user computing device 110. In an example embodiment, the user 101 submits a search query to the search system website 139 via the search application 113 or via the web browser 119. In an example embodiment, the user 101 may actuate one or more user interface 111 objects to direct the search application 113 or the web browser 119 to submit the search query to the search system website 139 over the network 140. For example, the user computing device 110 may comprise a touch screen keyboard interface that enables the user 101 to submit alphanumeric and/or symbolic characters to the search application 113 or web browser 119 application for use in a search query. In another example, the user 101 submits audio, video, or image input as a search query to the search application 113 and/or web browser 119 application. In an example embodiment, a user 101, after inputting a search query, actuates an object on the user interface 111 to submit the search query. For example, the user 101 may click, touch, or otherwise actuate an icon on the search application 113 or web browser 119 application that states “submit search query” or “search.” In an example embodiment, the search application 113 or the web browser 119 resident on the user computing device 110 communicates the search query inputted by the user to the search system website 139 via the network 140.

In block 330, the search system 130 receives the search query. For example, the search system website 139 receives the search query via the network 140 from the search application 113 or the web browser 119 application resident on the user computing device 110.

In block 340, the search system 130 retrieves images associated with the search query. In other example embodiments, the search system 130 retrieves one or more videos, audio files, text, and/or images. For example, the methods described herein to retrieve images may also be used to retrieve other types of search results, including videos, audio files, and text.

In an example embodiment, the search system 130 parses the received search query into one or more search terms or otherwise determines one or more search terms based on the received search query. For example, the user 101 submits a search query comprising text reading “brand A refrigerator model 1200X.” In this example, the search system 130 may interpret the search query as comprising search terms “refrigerator,” “brand A,” and “model 1200X.” In an example embodiment, the search system 130 retrieves images based on the search terms and ranks the retrieved images according to a compatibility with the search terms. In another example embodiment, the search system 130 retrieves one or more video files, audio files, text, and/or images. In an example, an image result of a brand A refrigerator model 1200X is more compatible with the user search terms “refrigerator,” “brand A,” and “model 1200X” than an image result of a brand A refrigerator model 500.

Continuing with this example, the image result of the brand A refrigerator model 500 is more compatible than an image result of a brand B refrigerator or a brand A freezer with the aforementioned search terms. In an example embodiment, the search system 130 may determine a compatibility of each of the retrieved image search results by comparing information associated with the image results against the one or more search terms. For example, the search system 130 may comprise a database comprising image search results, wherein each image search result is associated with one or more text descriptors. For example, an image result comprising an image of a brand A piano may comprise text descriptors “piano,” “brand A,” “musical instrument,” “brand A piano,” “brand A instrument,” and/or other relevant text descriptors associated with the image result. In this example, another image result comprising an image of a brand A electric organ may comprise descriptors “organ,” “electric organ,” “brand A,” “musical instrument,” “brand A electric organ,” and/or other relevant text descriptors associated with the image result. In this example, the user 101 submits a search query comprising the search term “brand A piano.” In this example, the search system 130 retrieves search results comprising the image of the brand A piano and the image of the brand A electric organ. In this example, the search system 130 determines that the image result of the brand A piano is more compatible with the user's 101 search query than the image result of the brand A organ because the text descriptor “brand A piano” associated with the image of the brand A piano more closely matches the search term in the search query than any of the text descriptors associated with the image of the brand A electric organ. In an example embodiment, text descriptors associated with an image result are entered manually by search system 130 operators into a search system 130 database. In another example embodiment, text descriptors associated with an image result are extracted from a website from which the image result was obtained by the search system 130. For example, the search system 130 may obtain an image from a publisher's website, wherein the publisher's website comprises a text description of the image displayed in proximity to the image. In this example, the search system 130 may generate one or more text descriptors to associated with the image based on the text description obtained from the publisher's website.

From block 340, the method 210 proceeds to block 220 of FIG. 2.

Returning to FIG. 2, in block 220, the search system 130 associates an offer with each image result. In other example embodiments, the search system 130 associates an offer with each video, audio, text, and/or image result.

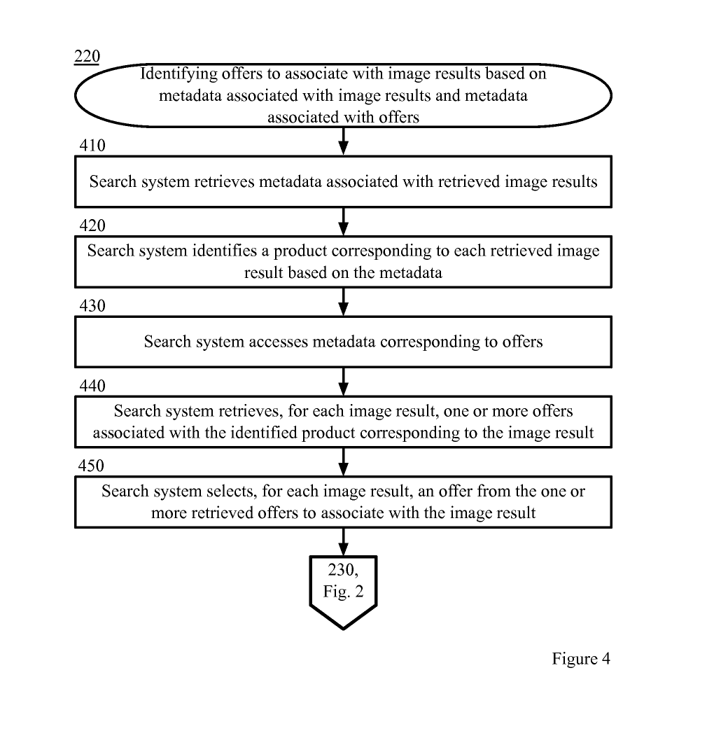

FIG. 4 is a block diagram depicting a method 220 for identifying offers to associate with image results based on metadata associated with image results and metadata associated with offers, in accordance with certain example embodiments. The methods described herein to associate an offer with each image result based on metadata associated with the image results and metadata associated with offers may also be used to associate offers with each of one or more of video search results, audio search results, and/or text search results based on metadata associated with the search results and metadata associated with offers. The method 220 is described with reference to the components illustrated in FIG. 1.

In block 410, the search system 130 retrieves metadata associated with the retrieved image results. In an example embodiment, one or more of the image results is a copy of an image from a publisher's website from which the search system 130 obtained the image result. In this example embodiment, the publisher's website may, in addition to the image, comprise a text description of the image in proximity to the image. In this example embodiment, the metadata comprises the text description of the image. For example, the publisher's website comprises an image of a brand A piano model X and a text description comprising a customer review of the brand A piano model X. In this example, the text description identifies the image as a brand A piano model X. For example, the text description may read “Here is my new brand A model X piano that I recently bought from online merchant A.” In this example, the text description comprises information that identifies the image as a brand A piano and a model X piano, and identifies an online merchant from which the piano in the image may be purchased.

In block 420, the search system 130 identifies a product corresponding to each retrieved image result based on the metadata. In an example embodiment, the search system 130 identifies a products corresponding to a particular image result based on metadata associated with the particular image result. For example, based on metadata associated with a retrieved image result comprising a text description from a publisher's website from which the search system 130 obtained the image result, the search system 130 identifies “brand A model X piano” as a product corresponding to the image result. In an example embodiment, the search system 130 identifies two or more products corresponding to a particular image result based on metadata associated with the particular image result. For example, based on the metadata associated with a particular image result, the search system 130 identifies “brand A model X piano” and “brand A piano bench” as products corresponding to the image result.

In an example embodiment, the search system 130 identifies a product corresponding to a particular image result by comparing the image result to one or more other image results for which the search system 130 has identified a corresponding product. In this example embodiment, the search system 130 may comprise a database of image results and associated products. For example, the database of image results and associated products may associate image results with products. In an example, an image result of a user 101 search query comprises an image of a brand A model X piano, but the search system 130 is unable to identify the image result as corresponding to the product “brand A model X piano” based on metadata associated with the image result. In this example, the search system 130 may compare one or more features of the image result of the user's 101 search query to one or more corresponding features of image results in the database of image results and associated products. In this example, features of the image result may comprise color, pattern, brightness, shape, space, texture, or other properties of the image or of regions of the image associated with the image result. In this example, the search system 130 determines the features of the image result of the user's 101 search query and compares the features of image result of the user's 101 search query against the features of image results in the search system's 130 database of image results, which comprises at least one image result of a brand A model X piano. In this example, the search system 130 identifies an image result in the database comprising an image associated with the product “brand A model X piano” as having features that are most similar to the features of the image result of the user's 101 search query. In this example, the search system 130 identifies the image result of the user's 101 search query as a brand A model X piano based on the comparison of features. In this example, the search system 130 may only identify the product of the user 101 search query image result using this method if, upon comparison, the corresponding features of the user 101 search query image result and an image result in the database exceed a predetermined threshold similarity.

In block 430, the search system 130 accesses metadata corresponding to offers. In an example embodiment, the search system 130 comprises a product offer listing catalog. In this example embodiment, the product offer listing catalog comprises a list of products and one or more offers associated with each listed product. In an example embodiment, the search system 130 obtains offers for products from one or more merchant systems 120. For example, the search system 130 comprises a web crawler that periodically extracts information comprising offers from one or more merchant system websites 129. In another example, one or more merchant systems 120 periodically transmit, via the network 140, a list of offers associated one or more products to the search system 120.

In block 440, the search system 130 retrieves, for each image result, one or more offers associated with the identified product corresponding to the image result. In an example embodiment, for each image search result, the search system 130 identifies a product in the image search result and retrieves one or more offers associated with the identified product in the product offer listing catalog. In another example embodiment, the search system 130 identifies two or more products in an image search result and retrieves one or more offers associated with each of the two or more identified products in the product offer listing catalog.

In block 450, the search system 130 selects, for each image result, an offer from the one or more retrieved offers to associate with the image result. In an example embodiment, the search system 130 selects an offer for which the search system 130 received a highest bid in an advertising auction. In this example embodiment, one or more merchant systems 120, in addition to transmitting offers to the search system 130 to include in the product offer listing catalog, submit bids for the offers. In this example embodiment, a merchant system 120 is charged for the amount of the bid if the search system 130 provides a purchase link to the offer in an image search result to a user 101. In another example embodiment, the search system 130 selects an offer from the one or more offers offering the user 101 the lowest price for the product compared to the other offers. For example, the lowest price may be the lowest price for the product or the lowest price that includes the sum of the price of the product and shipping costs. In yet another example embodiment, the search system 130 selects an offer from the one or more offers corresponding to the most reliable merchant system 120. For example, offers associated with a merchant systems 120 having a high number of positive user 101 and/or low number of negative user 101 reviews may be considered more reliable or trustworthy than offers associated with merchant systems 120 having a low number of positive user 101 reviews or a high quantity of negative user 101 reviews.

In yet another example embodiment, the search system 130 selects an offer from the one or more offers corresponding to a location of the merchant system 120 that is closest to a location of the user computing device 110 associated with the user 101 that submitted the search query. In this example embodiment, the search system 130 requests the user 101 location from the user computing device 110 over the network 140. In this example embodiment, the user 101 enables location-based services on the user computing device 110 and the user computing device 110 transmits the current location of the user computing device 110 to the search system 130. In this example embodiment, the search system 130 compares the received location of the user computing device 110 against locations of merchant systems 120 associated with one or more offers associated with an image result. In this example embodiment, the search system 130 selects an offer from the one or more offers corresponding to the shortest distance between the location of the user computing device 110 and the location of the merchant system 120.

In yet another example embodiment, a search system 130 may select an offer for each image search result based on preferences selected by the user 101 that submitted the search query. For example, the user 101 may select an option for the search system 130 to retrieve offers having the lowest price, offers having the most reliable merchant system 120, offers corresponding to merchant systems 120 in close proximity to the user 101 location based on user computing device 110 location data, or offers corresponding to another relevant user 101 preference.

From block 450, the method 220 proceeds to block 230 in FIG. 2.

Returning to FIG. 2, in block 230, the search system 130 identifies, for each image result, a purchase link associated with the selected offer corresponding to the image result. In other example embodiments, the search system 130 identifies, for each image search result, text search result, audio search result, and/or video search result, a purchase link associated with the selected offer corresponding to the corresponding search result. An example purchase link comprises a link to a merchant system website 129 from which the selected offer originated. In an example embodiment, the purchase link comprises a link that, when selected by the user 101 operating the user computing device 110, redirects the web browser 119 of the user computing device 110 to a merchant system website 129 that presents the offer to the user 101 and allows the user 101 to enter payment and/or shipping information to purchase the product. In another example embodiment, the purchase link comprises a link to a shopping system (not depicted) website offering the product for sale.

In block 240, the search system 130 generates, for each image result, a purchase icon within the image result comprising the corresponding purchase link. For example, the purchase icon is located at a margin, corner, or other appropriate region of the image result so as not to occlude the user's 101 view of the image result. In another example, the purchase icon is located at a margin, corner, or other appropriate region of a video search result, an audio search result, and/or a text search result. In an example embodiment, the purchase icon comprises a text format. For example, the purchase icon comprises a price of the selected offer associated with the image result displayed in a corner of the image result. In an example embodiment, the search system 130, when receiving an indication that a user 101 has selected a purchase icon, redirects the web browser 119 of the user computing device 110 associated with the user 101 to the website 129 associated with the purchase link.

In block 250, the search system 130 presents image results comprising corresponding purchase icons to the user computing device 110 to display in response to the user's 101 image search query. In other example embodiments, the search system 130 presents video, audio, image, and/or text results comprising corresponding purchase icons to the user computing device 110 to display in response to the user's 101 search query. For example, from the user's 101 perspective, the user 101 submitted an image search query or other search query to the search system 130 and the search system 130 presents the image results comprising the purchase icons to the user 101 in response to receiving the image search query. In another example embodiment, the search system 130 transmits an image result comprising a purchase icon to a publisher's website from which the offer associated with the image result was obtained by the search system 130. In this example embodiment, the publisher's website replaces the image result with the corresponding image result comprising the purchase icon.

In block 260, the user 101 selects a purchase icon of an image result. For example, the user 101 actuates an object of the user interface 111 to select a purchase icon of an image result. In an example embodiment, the user computing device 110 transmits, via the network 140 and to the search system 130, an indication of the user's 101 selection of the purchase icon of the image result. In an example embodiment, the search system 130 receives, from the user computing device 110 via the network 140, the indication of the selection of the purchase icon of the image result by the user 101. In an example embodiment, in response to receiving the indication of the user's 101 selection of the purchase icon, the search system 130 identifies the purchase link associated with the purchase icon.

In block 270, the user computing device web browser 119 is redirected to a merchant system website 129 associated with the purchase link. In an example embodiment, the search system 130 transmits instructions to the user computing device 110 comprising the purchase link and instructing the web browser 119 of the user computing device 110 to redirect to a website associated with the purchase link. In an example embodiment, the user computing device 110 receives the purchase link and the instructions from the search system 130 and instructs the web browser 119 to display the website 129 associated with the purchase link. In an example embodiment, the user computing device web browser 119 communicates with the merchant system server 127 via the network 140 to display the website 129 on the user computing device 110. In another example embodiment, the user computing device web browser 119 is not redirected to the merchant system website 129. In yet another example embodiment, the an application associated with the merchant system 120 and residing on the user computing device 110 executes on the user computing device 110 in response to the user 101 selecting the purchase icon. In this example embodiment, the application associated with the merchant system 120 communicates with the merchant system 120 via the network 140.

In block 280, the user 101 completes an online purchase of the product associated with the selected image result. In an example embodiment, after the user computing device web browser 119 is redirected to the merchant system website 129, the user 101 completes a transaction with the merchant system 120 via the merchant system website 129 to purchase the product associated with the selected image result. In another example embodiment, after an application associated with the merchant system 120 executes on the user computing device 110 in response to the user 101 selecting the purchase icon, the user 101 completes a transaction with the merchant system 120 via the application, which communicates with the merchant system 120 via the network 140.

In yet another example embodiment, the user computing device 110 web browser 119 is not redirected to the merchant system website 129 or does not communicate with the merchant system 120 via an application resident on the user computing device 110. In this example embodiment, a payment processing system associated with the search system 130 processes a first payment transaction to receive payment from an account of the user 101 for a value of the product associated with the selected image result. In this example embodiment, the payment processing system processes a second transaction to credit a merchant system 120 offering the product for sale using funds from an account of the payment processing system.

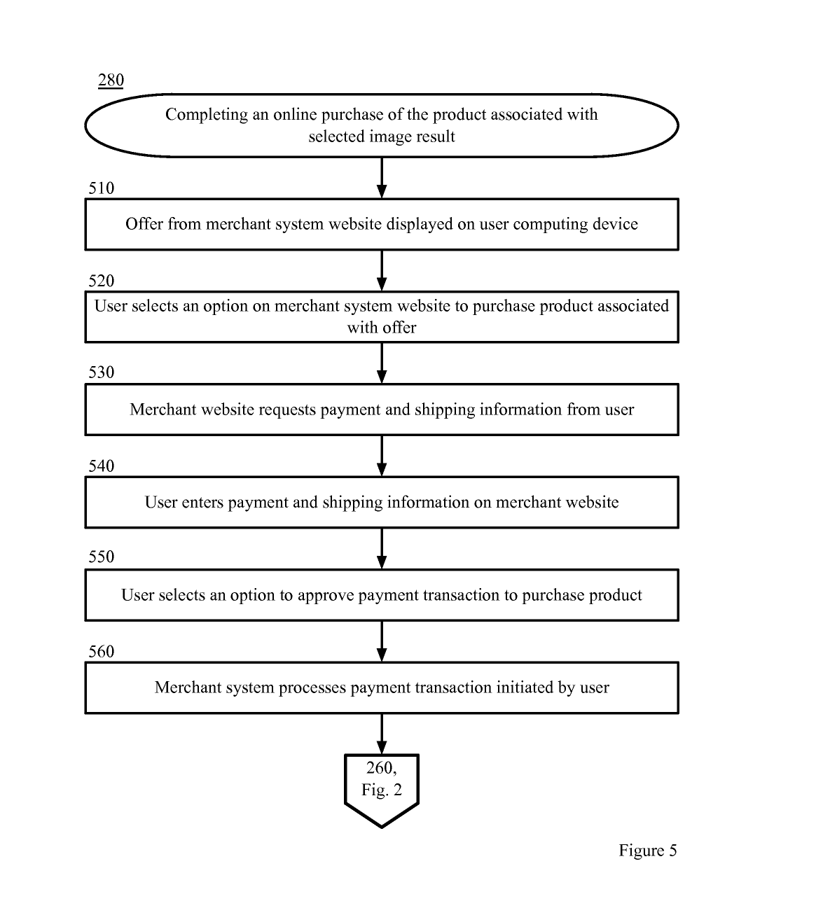

FIG. 5 is a block diagram depicting a method 280 for completing an online purchase of the product associated with selected image result, in accordance with certain example embodiments. The method 280 is described with reference to the components illustrated in FIG. 1. In these example embodiments, the user 101 completes a transaction via the merchant system website 129. In other example embodiments, one or more actions performed by the merchant system website 129 may also be performed by an application associated with the merchant system 120 and executing on the user computing device 110, wherein the application communicates with the merchant system 120 via the network 140.

In block 510, the offer from the merchant system website 129 is displayed on the user computing device 110. In an example embodiment, the merchant system website 129 associated with the purchase link displays the product associated with the selected image result in a virtual shopping cart. In this example embodiment, the merchant system website 129 may also display an option to the user to initiate a purchase of the product in displayed in the virtual shopping cart. In this example embodiment, the merchant system website 129 may also display the price of the product being offered for sale and any other relevant information associated with the product.

In block 520, the user 101 selects an option on the merchant system website 129 to purchase the product associated with the offer. For example, the user 101 actuates an object on the user interface 111 of the user computing device 110 to select the option displayed on the website 129 to purchase the product associated with the offer. In an example embodiment, the user computing device web browser 119 communicates an indication of the user's 101 selection of the option to purchase to the merchant system website 129.

In block 530, the merchant system website 129 requests payment and shipping information from the user 101. For example, in response to receiving an indication of a user 101 selection of the option to purchase the product associated with the offer, the merchant system website 129 transmits a command to the user computing device 110 for payment information and/or shipping information from the user 101. In an example embodiment, the user computing device 110 displays the request for payment and/or shipping information to the user 101.

In block 540, the user 101 enters payment and shipping information on the merchant system website 129. For example, the user 101 enters payment information corresponding to one or more of a credit card number, a debit card number, a bank account number, a coupon number, or other applicable payment information. In this example, the user 101 may also enter a card verification value (CVV), an expiration date, a zip code, or other additional information associated with a payment instrument. In an example, the user 101 enters a shipping address comprising a street name, a mailbox number, a city, a state, a zip code, and a telephone number. In an example embodiment, the merchant system website 129 receives the payment and shipping information entered by the user via the user computing device 110 over the network 140.

In block 550, the user 101 selects an option to approve a payment transaction to purchase the product. In an example embodiment, the merchant system website 129, in response to receiving the user's 101 shipping information and payment information, displays an option to approve a payment transaction to purchase the product. In an example embodiment, the user 101 actuates one or more objects on the user interface 111 to select the option to approve the payment transaction. For example, the user 101 clicks on an option reading “confirm” to approve the payment transaction.

In block 560, the merchant system 120 processes a payment transaction initiated by the user 101. In an example embodiment, the merchant system 120 communicates with an issuer system (not depicted) associated with the payment information provided by the user 101 for use in the transaction. For example, the user 101 provided a credit card number to use in the transaction. In this example, the merchant system 120 communicates a payment authorization request to a credit card issuer associated with the credit card number via an acquirer system associated with the credit card. In this example, the credit card issuer approves the payment authorization request and transmits a notification of approval of the payment authorization request to the merchant system 120. In this example, the merchant system 120 transmits a receipt to the user computing device 110 confirming the success of the user's 101 transaction to purchase the product. In another example embodiment, the merchant system 120 communicates with a bank, a coupon issuer, or other appropriate issuer system or financial entity to process a transaction. In an example embodiment, an account of the user 101 is debited for the amount of the transaction and an account of the merchant system 120 is credited for the same amount. In another example embodiment, an account of a third party is debited for an amount and an account of the merchant system 120 is credited for the same amount. For example, the user 101 used a coupon to pay for all or part of the transaction amount and a coupon issuer account is debited for the amount of the coupon and the merchant system 120 is credited for the amount of the coupon.

In other example embodiments, the user computing device web browser 119 is not redirected to the merchant system website 129 and the user 101 does not directly transact with the merchant system 120. In this example embodiment, a payment processing system (not depicted) associated with the search system 130 processes a first payment transaction to receive payment from an account of the user 101 for a value of the product associated with the selected image result. As previously discussed, the search system 130 identifies, for each image result, a purchase link associated with the selected offer corresponding to the image result. In an example embodiment, the search system 130 communicates with the merchant system 120 associated with the purchase link to determine the cost of the product offered for sale by the merchant system 120. For example, the search system 120 and/or the payment processing system transmits a request for the price of the product, tax information for the product, and any other applicable pricing information for the product. In this example, the merchant system 120 transmits the pricing information for the product to the payment processing system. In this example, the payment processing system determines a total cost of the product based on the pricing information received from the merchant system 120.

Continuing with this example embodiment, the payment processing system associated with the search system 130 may transmit a request for payment account information to the user computing device 110, which displays the request for payment account information to the user 101. In an example, the user 101 enters payment account information via the user interface 111 of the user computing device 110 and the user computing device 110 transmits the payment account information to the payment processing system. In another example, the user 101 has a digital wallet account managed by and associated with the payment processing system. In this example, the digital wallet account comprises payment account information associated with one or more financial accounts of the user 101. In this example, the payment processing system transmits a command to the user computing device 110 to display one or more payment options comprising payment account information of the user 101 to the user 101. In this example, the user 101 selects payment account information from the one or more displayed payment options. In this example, the user computing device 110 communicates the user 101 selection of the payment account information to the payment processing system. In this example embodiment, the payment processing system communicates with an issuer system associated with the payment account information selected by the user 101 or the payment account information received from the user 101 to process a payment transaction. For example, funds are transferred from an account of the user 101 to an account of the payment processing system.

Continuing with this example embodiment, the payment processing system processes a second transaction to credit a merchant system 120 offering the product for sale using funds from an account of the payment processing system. For example, funds are transferred from an account of the payment processing system to an account of the merchant system 120 offering the product for sale. In an example embodiment, the payment processing system transmits shipping information associated with the user 101 to the merchant system 120 so that the merchant system 120 can ship the product to an address of the user 101 or otherwise physically or electronically deliver the product to the user 101.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to provide search results comprising purchase links, comprising:
receiving, by one or more computing devices and from a user computing device, a search query;
retrieving, by the one or more computing devices, one or more search results associated with one or more terms of the search query and search result metadata associated with the one or more search results;
retrieving, by the one or more computing devices, offer metadata corresponding to a plurality of offers;
for each of the retrieved search results:
identifying, by the one or more computing devices, a product corresponding to the search result based on the search result metadata;
identifying, by the one or more computing devices, one or more offers of the plurality of offers offering the identified product for sale;
selecting, by the one or more computing devices, a particular offer of the one or more offers; and
determining, by the one or more computing devices, a purchase link associated with the particular offer, wherein the purchase link directs the user computing device to a merchant system website offering the product for sale in response to a user selecting the purchase link via the user computing device;
generating, by the one or more computing devices, a purchase icon comprising the purchase link associated with the particular offer to be displayed with the retrieved search results;
transmitting, by the one or more computing devices and to the user computing device, the retrieved search results comprising the respective purchase icons for display on the user computing device.

2. The method of claim 1, further comprising:
receiving, by the one or more computing devices and from the user computing device, an indication of a selection by the user of a purchase icon corresponding to a particular image result; and
transmitting, by the one or more computing devices and to the user computing device, a request for the web browser of the user computing device to redirect to the merchant system website corresponding to the purchase link.

3. The method of claim 2, wherein the user purchases the product from the merchant system website via the user computing device.

4. The method of claim 1, further comprising:
receiving, by the one or more computing devices and from the user computing device, an indication of a selection by the user of a purchase icon corresponding to a particular image result; and
transmitting, by the one or more computing devices and to the user computing device, a request for an application associated with the merchant system resident on the user computing device to communicate with the merchant system website corresponding to the purchase link.

5. The method of claim 1, further comprising:
receiving, by the one or more computing devices and from the user computing device, an indication of a selection by the user of a purchase icon corresponding to a particular image result;
transmitting, by the one or more computing devices and to the merchant system website corresponding to the purchase link, a request for pricing information associated with the product;
receiving, by the one or more computing devices and from the merchant system website, pricing information associated with the product;
determining, by the one or more computing devices and based on the pricing information, a total cost of the product;
transmitting, by the one or more computing devices and to the user computing device, a request for payment information from the user, wherein the user enters or selects payment information via the user computing device;
receiving, by the one or more computing devices and from the user computing device, payment information of the user;
processing, by the one or more computing devices, a first transaction to receive payment from the user for the total cost of the product using the payment information of the user; and
processing, by the one or more computing devices, a second transaction to credit the merchant system for the total cost of the product.

6. The method of claim 1, wherein the one or more search results comprise image search results.

7. The method of claim 6, wherein the search result metadata corresponding to each of the one or more image search results comprises text within a predefined proximity of the respective image search result as displayed on a publisher's website to which the image search result pertains.

8. The method of claim 1, wherein the one or more search results comprise one or more of video search results, text search results, image search results, and audio search results.

9. The method of claim 1, wherein the search result metadata comprises contextual information associated with the search result as displayed on a publisher's website to which the search result pertains.

10. A computer program product, comprising:
a non-transitory computer-readable medium having computer-readable program instructions embodied thereon that when executed by a computer cause the computer to provide search results comprising purchase links, the computer-readable program instructions comprising:
computer-readable program instructions to receive a search query;
computer-readable program instructions to retrieve one or more search results associated with one or more terms of the search query and search result metadata associated with the one or more search results;
computer-readable program instructions to retrieve offer metadata corresponding to a plurality of offers;
for each of the retrieved search results:
computer-readable program instructions to identify a product corresponding to the search result based on the search result metadata;
computer-readable program instructions to identify one or more offers of the plurality of offers offering the identified product for sale;
computer-readable program instructions to select a particular offer of the one or more offers;
computer-readable program instructions to determine a purchase link associated with the particular offer, wherein the purchase link directs the user computing device to a merchant system website offering the product for sale in response to a user selecting the purchase link via the user computing device;
computer-readable program instructions to generate a purchase icon comprising the purchase link associated with the particular offer to be displayed with the retrieved search results; and
computer-readable program instructions to transmit, to the user computing device, the retrieved search results comprising the respective purchase icons for display on the user computing device.

11. The computer program product of claim 10, further comprising:
computer-readable program instructions to receive, from the user computing device, an indication of a selection by the user of a purchase icon corresponding to a particular image result; and
computer-readable program instructions to transmit, to the user computing device, a request for the web browser of the user computing device to redirect to the merchant system website corresponding to the purchase link.

12. The computer program product of claim 10, further comprising:
computer-readable program instructions to receive, from the user computing device, an indication of a selection by the user of a purchase icon corresponding to a particular image result; and
computer-readable program instructions to transmit, to the user computing device, a request for an application associated with the merchant system resident on the user computing device to communicate with the merchant system website corresponding to the purchase link.

13. The computer program product of claim 12, wherein the user purchases the product from the merchant system website via the user computing device.

14. The computer program product of claim 10, wherein the one or more search results comprise one or more of video search results, text search results, image search results, and audio search results.

15. The computer program product of claim 10, further comprising:
computer-readable program instructions to receive, from the user computing device, an indication of a selection by the user of a purchase icon corresponding to a particular image result;
computer-readable program instructions to transmit, to the merchant system website corresponding to the purchase link, a request for pricing information associated with the product;
computer-readable program instructions to receive, from the merchant system website, pricing information associated with the product;
computer-readable program instructions to determine, based on the pricing information, a total cost of the product;
computer-readable program instructions to transmit, to the user computing device, a request for payment information from the user, wherein the user enters or selects payment information via the user computing device;
computer-readable program instructions to receive, from the user computing device, payment information of the user;
computer-readable program instructions to process a first transaction to receive payment from the user for the total cost of the product using the payment information of the user; and
computer-readable program instructions to process a second transaction to credit the merchant system for the total cost of the product.

16. The computer program product of claim 10, wherein the search result metadata comprises contextual information associated with the search result as displayed on a publisher's website to which the search result pertains.

17. A system to provide search results comprising purchase links, comprising:
a storage device; and
a processor communicatively coupled to the storage device, wherein the processor executes application code instructions that are stored in the storage device to cause the system to:
receive a search query;
retrieve one or more search results associated with one or more terms of the search query and search result metadata associated with the one or more search results;
retrieve offer metadata corresponding to a plurality of offers;
for each of the retrieved search results:
identify a product corresponding to the search result based on the search result metadata;
identify one or more offers of the plurality of offers offering the identified product for sale;
select a particular offer of the one or more offers;
determine a purchase link associated with the particular offer, wherein the purchase link directs the user computing device to a merchant system website offering the product for sale in response to a user selecting the purchase link via the user computing device;
generate a purchase icon comprising the purchase link associated with the particular offer to be displayed with the retrieved search results; and
transmit, to the user computing device, the retrieved search results comprising the respective purchase icons for display on the user computing device.

18. The system of claim 17, wherein the processor is further configured to execute computer-readable program instructions stored in the storage medium to cause the system to:
receive, from the user computing device, an indication of a selection by the user of a purchase icon corresponding to a particular image result;
transmit, to the merchant system website corresponding to the purchase link, a request for pricing information associated with the product;
receive, from the merchant system website, pricing information associated with the product;
determine, based on the pricing information, a total cost of the product;
transmit, to the user computing device, a request for payment information from the user, wherein the user enters or selects payment information via the user computing device;
receive, from the user computing device, payment information of the user;
process a first transaction to receive payment from the user for the total cost of the product using the payment information of the user; and
process a second transaction to credit the merchant system for the total cost of the product.

19. The system of claim 17, wherein the processor is further configured to execute computer-readable program instructions stored in the storage medium to cause the system to:
receive, from the user computing device, an indication of a selection by the user of a purchase icon corresponding to a particular image result; and
transmit, to the user computing device, a request for the web browser of the user computing device to redirect to the merchant system website corresponding to the purchase link.

20. The system of claim 17, wherein the processor is further configured to execute computer-readable program instructions stored in the storage medium to cause the system to:
receive, from the user computing device, an indication of a selection by the user of a purchase icon corresponding to a particular image result; and
transmit, to the user computing device, a request for an application associated with the merchant system resident on the user computing device to communicate with the merchant system website corresponding to the purchase link.
